(19) United States
(12) Patent Application Publication
(10) Pub. No.: US 2015/0371735 A1
(43) Pub. Date: Dec. 24, 2015

(54) INSULATED WIRE

(71) Applicant: Hitachi Metals, Ltd., Tokyo (JP)

(72) Inventors: Makoto IWASAKI, Hitachi (JP); Hiroshi OKIKAWA, Hitachi (JP); Mitsuru HASHIMOTO, Hitachi (JP); Kenichiro FUJIMOTO, Hitachi (JP)

(21) Appl. No.: 14/732,687

(22) Filed: Jun. 6, 2015

(30) Foreign Application Priority Data
Jun. 19, 2014 (JP) 2014-126225
Oct. 31, 2014 (JP) 2014-222111

(51) Int. Cl. H01B 7/29; H01B 1/02; H01B 7/02; C08L 23/08

(52) U.S. Cl. CPC H01B 7/29; C08L 23/08; C08L 23/0853; H01B 1/02; H01B 7/0216; C08L 2201/02; C08L 2203/202; C08L 2205/025; C08L 2205/035

(57) ABSTRACT

An insulated wire includes a conductor, and an insulating cover layer including an inner layer on an outer periphery of the conductor and an outer layer on an outer periphery of the inner layer. The inner layer includes a halogen-free resin composition including base polymer (A), which includes a first ethylene-α-olefin copolymer (a1) and a second ethylene-α-olefin copolymer (a2) at a ratio of 50:50 to 90:10, the first ethylene-α-olefin copolymer (a1) having a density of not less than 0.864 g/cm3 and not more than 0.890 g/cm3, a melting point of not more than 90° C. and a melt flow rate of not less than 1 g/10 min and not more than 5 g/10 min, and the second ethylene-α-olefin copolymer (a2) having a melting point of not less than 55° C. and not more than 80° C. and a melt flow rate of not less than 30 g/10 min.

The present application is based on Japanese patent application Nos. 2014-126225 and 2014-222111 filed on Jun. 19, 2014 and Oct. 31, 2014, respectively, the entire contents of which are incorporated herein by reference.

### BACKGROUND OF THE INVENTION

1. Field of the Invention

The invention relates to an insulated wire.

2. Description of the Related Art

An insulated wire has been proposed in which an insulating cover layer with inner and outer layers is formed on an outer periphery of a conductor (see e.g. JP-A-2010-97881). JP-A-2010-97881 discloses an insulated wire that the inner layer is formed of a halogen-free resin composition having predetermined insulation properties (electrical characteristics) and the outer layer covering the inner layer is formed of a halogen-free flame-retardant resin composition having flame retardancy so as to provide electrical characteristics and flame retardancy.

### SUMMARY OF THE INVENTION

Insulated wires used for rolling stocks or automobiles need to have various characteristics in terms of safety and durability. Specifically, the insulated wires need to have a good balance between flexibility and mechanical strength and also higher flame retardancy and fuel resistance.

In addition to the above characteristics, the insulated wires need to be adapted to easily form the insulating cover layer with the inner and outer layers so as to improve the productivity.

It is an object of the invention to provide an insulated wire that has a good balance between flexibility and mechanical strength and that is excellent in flame retardancy, fuel resistance and productivity.

According to one embodiment of the invention, an insulated wire comprises:

a conductor; and

an insulating cover layer comprising an inner layer on an outer periphery of the conductor and an outer layer on an outer periphery of the inner layer,

wherein the inner layer comprises a halogen-free resin composition comprising 100 parts by mass of base polymer (A), not less than 80 parts by mass and not more than 150 parts by mass of inorganic filler (B) and a cross-linking agent (C), wherein the base polymer (A) comprises a first ethylene-α-olefin copolymer (a1) and a second ethylene-α-olefin copolymer (a2) at a ratio of 50:50 to 90:10, the first ethylene-α-olefin copolymer (a1) having a density of not less than 0.864 g/cm³ and not more than 0.890 g/cm³, a melting point of not more than 90° C. and a melt flow rate of not less than 1 g/10 min and not more than 5 g/10 min, and the second ethylene-α-olefin copolymer (a2) having a melting point of not less than 55° C. and not more than 80° C. and a melt flow rate of not less than 30 g/10 min,

wherein the outer layer comprises a halogen-free flame-retardant resin composition comprising 100 parts by mass of base polymer (D) and not less than 100 parts by mass and not more than 250 parts by mass of halogen-free flame retardant (E), wherein the base polymer (D) comprises an ethylene-vinyl acetate copolymer (d1) comprising an ethylene-vinyl acetate copolymer with a melting point of not less than 70° C. and an acid-modified polyolefin resin (d2) having a glass-transition temperature of not more than −55° C. at a ratio of 70:30 to 99:1, and

wherein the base polymer (D) further comprises not less than 25 mass % and not more than 50 mass % of vinyl acetate component derived from the ethylene-vinyl acetate copolymer (d1).

### Effects of the Invention

According to one embodiment of the invention, an insulated wire can be provided that has a good balance between flexibility and mechanical strength and that is excellent in flame retardancy, fuel resistance and productivity.

### BRIEF DESCRIPTION OF THE DRAWING

Next, the present invention will be explained in more detail in conjunction with appended drawing, wherein:

FIG. 1 is a cross sectional view showing an insulated wire in an embodiment of the present invention.

### DETAILED DESCRIPTION OF THE PREFERRED EMBODIMENTS

In order to solve the problems mentioned above, the present inventors studied respective materials of inner and outer layers of an insulating cover layer.

In a halogen-free resin composition (hereinafter, also simply referred to as “resin composition”) used to form an inner layer, a rubber could be used as a base polymer from the viewpoint of obtaining excellent flexibility. However, since general rubbers do not have melting points, resin compositions containing rubbers may stick and block at ambient temperatures. When, for example, a resin composition containing a rubber is processed into pellets, the pellets stick together and agglomerate into large clumps which cause blocking. It is difficult to extrude the blocked pellets, which results in that it is not possible to form the inner layer with high productivity.

The inventors studied various rubbers and then focused on ethylene-α-olefin copolymers. Ethylene-α-olefin copolymers have a block structure in which crystalline polymer blocks with high rigidity (ethylene) and amorphous polymer blocks excellent in rubber elasticity (α-olefin) are alternately arranged. Among rubbers, the ethylene-α-olefin copolymers have relatively high melting points due to having crystalline polymer blocks and are less likely to cause blocking. In addition, the ethylene-α-olefin copolymers are also excellent in flexibility and mechanical strength since amorphous polymer blocks have rubber elasticity (suppleness).

However, it was found that, in case of using ethylene-α-olefin copolymers having a melting point of more than 90° C., scorching (premature cross-linking) of resin composition occurs during manufacturing of the resin composition when melting and kneading with a cross-linking agent while heating. Scorching impairs extrusion processability at the time of extruding the resin composition and thus causes a decrease in productivity of the inner layer.

From this fact, it was found that an ethylene-α-olefin copolymer having a predetermined melting point should be used from the viewpoint of preventing blocking and scorching. In addition, it was also found that another ethylene-α-olefin copolymer having a different melt flow rate (MFR) should be combined from the viewpoint of achieving a good balance between flexibility and mechanical strength of the inner layer. In detail, it was found that it is exemplary to use a base polymer which contains an ethylene-α-olefin copolymer having a melting point of not more than 90° C. and a MFR of not less than 1 g/10 min and not more than 5 g/10 min and another ethylene-α-olefin copolymer having a melting point of not less than 55° C. and not more than 80° C. and a MFR of not less than 30 g/10 min.

Meanwhile, for a halogen-free flame-retardant resin composition (hereinafter, also simply referred to as “flame-retardant resin composition”) used to form the outer layer, it is exemplary to use a high-polarity base polymer containing an ethylene-vinyl acetate copolymer (EVA) and an acid-modified polyolefin resin from the viewpoint of obtaining excellent flame retardancy and fuel resistance. EVAs contain a vinyl acetate (VA) component having a polar group and is polarized. The polarized EVAs are excellent in flame retardancy and fuel resistance. Since the polarity of EVA increases with an increase in the content of the vinyl acetate component (hereinafter, also referred to as “VA content”), EVAs with high VA content can be used to improve flame retardancy and fuel resistance. However, if the polarity of the base polymer is too high, the flame-retardant resin composition is likely to cause blocking and it is not possible to form the outer layer with high productivity.

The inventors studied this point and found that, when the VA content in the base polymer containing an EVA is more than 50 mass %, it is possible to ensure flame retardancy and fuel resistance of the flame-retardant resin composition but blocking is likely to occur due to too high polarity. The VA content in the base polymer could be adjusted to not more than 50 mass % to prevent blocking, but reducing the VA content to not more than 50 mass % causes a decrease in polarity and a resulting decrease in especially fuel resistance of the outer layer.

Therefore, the inventors studied a method of compensating and complementing fuel resistance which is decreased by reducing the VA content in the base polymer to not more than 50 mass %. As a result, it was found that EVAs having a melting point of not less than 70° C. should be used. EVAs having a melting point of not less than 70° C. are excellent in fuel resistance due to having high crystallinity which does not allow fuel etc., to easily penetrate between molecules. Therefore, it is possible to improve fuel resistance of the flame-retardant resin composition by mixing a predetermined EVA to the base polymer. In addition, since EVAs having a melting point of not less than 70° C. are less likely to stick together, it is possible to prevent blocking of the flame-retardant resin composition by mixing such an EVA to the base polymer. Therefore, when using the flame-retardant resin composition containing a predetermined EVA, it is possible form an outer layer excellent in flame retardancy and fuel resistance with high productivity. The present invention was made based on such a discovery.

### EMBODIMENTS OF THE INVENTION

Embodiments of the invention will be described below.

(1) Configuration of Insulated Wire

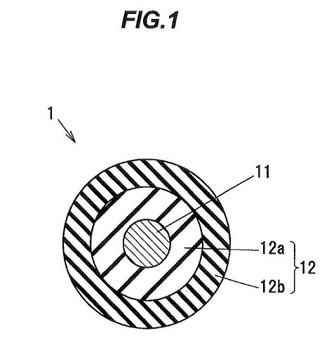

An insulated wire 1 in an embodiment of the invention will be described. FIG. 1 is a cross sectional view showing the insulated wire 1 in an embodiment of the present invention.

Conductor

As shown in FIG. 1, the insulated wire 1 is provided with a conductor 11. As the conductor 11, it is possible to use a commonly-used metal wire such as copper wire or copper alloy wire, an aluminum wire, a gold wire and a silver wire, etc. A metal wire plated with tin or nickel, etc., may be also used. Furthermore, it is also possible to use a bunch stranded conductor formed by twisting metal wires together.

Insulating Cover Layer

An insulating cover layer 12 is provided so as to cover the outer periphery of the conductor 11. The insulating cover layer 12 has an inner layer 12a covering the outer periphery of the conductor 11 and an outer layer 12b covering the outer periphery of the inner layer 12a.

Inner Layer

The inner layer 12a is formed of a halogen-free resin composition (hereinafter, also simply referred to as “resin composition”) which contains a base polymer (A), an inorganic filler (B) and a cross-linking agent (C). In detail, the resin composition is extruded on the outer periphery of the conductor 11 and is then cross-linked, thereby forming the inner layer 12a.

Base Polymer (A)

The base polymer (A) contains a first ethylene-α-olefin copolymer (a1) having predetermined characteristics and a second ethylene-α-olefin copolymer (a2) having different characteristics from the first ethylene-α-olefin copolymer (a1).

The first ethylene-α-olefin copolymer (a1) (hereinafter, also simply referred to as “first copolymer (a1)”) has a density of not less than 0.864 g/cm³ and not more than 0.890 g/cm³, a melting point of not more than 90° C. and a melt flow rate (MFR) of not less than 1 g/10 min and not more than 5 g/10 min. The first copolymer (a1) is a component having a low MFR and a high molecular weight. The first copolymer (a1) having such characteristics contributes to improvement in mechanical strength of the inner layer 12a. The base polymer (A) contains at least one type of the first copolymer (a1).

When the MFR of the first copolymer (a1) is less than 1 g/10 min, molecular weight is excessively high, causing a decrease in a discharge rate of the extruded resin composition and a resulting decrease in productivity of the inner layer 12a. When the MFR is more than 5 g/10 min, molecular weight is low and mechanical strength of the inner layer 12a thus decreases.

Mechanical strength of the inner layer 12a is reduced when the density of the first copolymer (a1) is less than 0.864 g/cm³, while flexibility of the inner layer 12a decreases when the density is more than 0.890 g/cm³.

When the first copolymer (a1) has a melting point of more than 90° C., it is necessary to increase a heating temperature during melting and kneading of the resin composition. The elevated heating temperature causes unintended cross-linking reaction (scorching, or premature cross-linking) due to pyrolysis of a cross-linking agent (e.g., organic peroxide) during kneading of the resin composition. As a result, extrusion processability of the resin composition is impaired and appearance of the inner layer 12a after extrusion becomes poor.

The second ethylene-α-olefin copolymer (a2) (hereinafter, also simply referred to as “second copolymer (a2)”) has a melting point of not less than 55° C. and not more than 80° C. and a melt flow rate of not less than 30 g/10 min. The second copolymer (a2) is a component having a relatively high MFR and a relatively low molecular weight. The second copolymer (a2) having such characteristics contributes to improvement in flexibility of the inner layer 12a. The base polymer (A) contains at least one type of the second copolymer (a2).

When the MFR of the second copolymer (a2) is less than 30 g/10 min, molecular weight is high and a discharge rate of the extruded resin composition decreases. This causes a decrease in productivity of the inner layer 12a.

When the second copolymer (a2) has a melting point of less than 55° C., blocking of the resin composition occurs. That is, the second copolymer (a2) which is a low-molecular-weight component becomes tackier when having a lower melting point and thus causes the resin composition to block. On the other hand, scorching of the resin composition occurs when the melting point of the second copolymer (a2) is more than 80° C., resulting in that extrusion processability of the resin composition is impaired and appearance of the inner layer 12a after extrusion becomes poor.

As the first copolymer (a1) and the second copolymer (a2), it is possible to use, e.g., a copolymer of ethylene and α-olefin having a carbon number of 3 to 12. The α-olefin is, e.g., propylene, 1-butene, 1-pentene, 1-hexene, 4-methyl-pentene, 1-heptene and 1-octene, etc., and may be either linear or branched. A catalyst used for manufacturing the ethylene-α-olefin copolymer is not specifically limited as long as ethylene and α-olefin are smoothly copolymerized. Examples of catalyst include transition metal catalysts such as vanadium series, titanium system or metallocene compound, and organometallic complex catalysts, etc. Copolymers formed using a metallocene compound catalyst and having a low melting point and a carbon number of 4 to 6 providing good flexibility are particularly exemplary.

It is possible to control the balance between mechanical strength and flexibility of the inner layer 12a by changing a ratio of the first copolymer (a1) to the second copolymer (a2) in the base polymer (A). In detail, the ratio of the first copolymer (a1) to the second copolymer (a2) is 50:50 to 90:10. When the first copolymer (a1) is contained in an amount of less than 50 mass %, the amount of the first copolymer (a1) contributing to mechanical strength is small and mechanical strength of the inner layer 12a thus decreases. When the first copolymer (a1) is contained in an amount of more than 90 mass %, the amount of the second copolymer (a2) contributing to flexibility is relatively reduced, causing the inner layer 12a to have excessively high mechanical strength and small flexibility.

Inorganic Filler (B)

The inorganic filler (B) is added to reduce toxic gas (e.g., carbon monoxide, etc.) which is produced when the inner layer 12a formed of the resin composition is burnt. As the inorganic filler (B), it is possible to use, e.g., silicates such as kaolinite, kaolin clay, baked clay, talc, mica, wollastonite and pyrophyllite, oxides such as silica, alumina, zinc oxide, calcium oxide and magnesium oxide, carbonates such as calcium carbonate, zinc carbonate and barium carbonate, and hydroxides such as calcium hydroxide, magnesium hydroxide and aluminum hydroxide, which can be used alone or in combination of two or more. Of those, baked clay and talc are exemplary since they do not contain carbon and are hydrophobic, and thus produce only a small amount of carbon monoxide and exhibit high electrical characteristics. In addition, it is exemplary that these inorganic fillers (B) be surface-treated with silane, etc., to improve adhesion to the base polymer since improved adhesion provides higher insulation properties.

In the resin composition, the inorganic filler (B) is contained in an amount of not less than 80 parts by mass and not more than 150 parts by mass with respect to 100 parts by mass of base polymer (A). If less than 80 parts by mass, the amount of carbon monoxide to be produced during burning of the inner layer 12a may increase. If more than 150 parts by mass, flexibility of the inner layer 12a may decrease.

The average particle size of the inorganic filler (B) is not less than 0.8 μm and not more than 2.5 μm. When less than 0.8 μm, the inorganic filler (B) has a larger surface area and is in contact with the base polymer (A) over a larger area. As a result, water easily permeates the inner layer 12a under immersion in water and electrical characteristics significantly deteriorate. When more than 2.5 μm, mechanical strength of the inner layer 12a may decrease.

Cross-Linking Agent (C)

An organic peroxide is used as the cross-linking agent (C). Examples of organic peroxide include hydroperoxide, diacyl peroxide, peroxyester, dialkyl peroxide, ketone peroxide, peroxyketal, peroxydicarbonate and peroxymonocarbonate, etc.

Exemplarily, the cross-linking agent (C) is contained in an amount of not less than 0.1 parts by mass and not more than 5 parts by mass with respect to 100 parts by mass of base polymer (A).

Other Additives

The resin composition, if necessary, may contain a crosslinking aid, a flame-retardant aid, an ultraviolet absorber, a light stabilizer, a softener, a lubricant, a colorant, a reinforcing agent, a surface active agent, a plasticizer, a metal chelator, a foaming agent, a compatibilizing agent, a processing aid and a stabilizer, etc. It is possible to add these additives within a range not impairing characteristics of the resin composition.

Outer Layer

The outer layer 12b is provided so as to cover the outer periphery of the inner layer 12a, as shown in FIG. 1. The outer layer 12b is formed of a halogen-free flame-retardant resin composition (hereinafter, also simply referred to as “flame-retardant resin composition”) which contains a base polymer (D) and a halogen-free flame retardant (E). In detail, the flame-retardant resin composition is extruded on the outer periphery of the inner layer 12a and is then cross-linked, thereby forming the outer layer 12b.

Base Polymer (D)

The base polymer (D) contain an ethylene-vinyl acetate copolymer (d1) (hereinafter, also simply referred to as “EVA (d1)”) and an acid-modified polyolefin resin (d2).

The EVA (d1) includes at least one type of EVAs having a melting point (Tm) of not less than 70° C. Due to having high crystallinity, EVAs having a melting point of not less than 70° C. prevent blocking of the flame-retardant resin composition and thus improve anti-blocking characteristics of the flame-retardant resin composition. Such EVAs also improves fuel resistance of the outer layer 12b. In general, EVAs having a lower melting point tend to have lower crystallinity and to contain more VA. Since EVAs having a melting point of less than 70° C. contain less VA and are less crystalline, blocking of the flame-retardant resin composition is likely to occur and fuel resistance of the outer layer 12b also decreases. The upper limit of the melting point of EVA is not specifically limited but is exemplarily not more than 100° C., more exemplarily not more than 95° C., further exemplarily not more than 90° C. so that the VA content in the base polymer (D) can be easily adjusted to a range of not less than 25 mass % and not more than 50 mass %. EVAs having a melting point of not less than 70° C. and not more than 100° C. contain VA in an amount of, e.g., not less than 6 mass % and not more than 28 mass %. The melting point here is a temperature measured by differential scanning calorimetry (DSC technique).

The EVA (d1) may include EVAs having a melting point of less than 70° C., in addition to the above-mentioned EVAs having a melting point of not less than 70° C. The EVAs having a melting point of less than 70° C. are polymers which have a lower crystallinity than the EVAs having a melting point of not less than 70° C. or are amorphous and contain a relatively large amount of VA. The EVAs having a melting point of less than 70° C. contain VA in an amount of, e.g., not less than 28 mass %. The VA content in the base polymer (D) is easily adjusted to a range of not less than 25 mass % and not more than 50 mass % by combining an EVA having a melting point of less than 70° C., as will hereinafter be described in detail.

The EVA (d1) also includes at least one type of EVAs having a melt mass flow rate (MFR) of not less than 6 g/10 min. It is more exemplary if the EVAs having a melting point of not less than 70° C. satisfy a MFR of not less than 6 g/10 min. By using an EVA having a MFR of not less than 6 g/10 min, it is possible to increase flowability (melt flow property) of the molten flame-retardant resin composition and thus to improve productivity of the outer layer 12b which is formed by extruding the flame-retardant resin composition.

The acid-modified polyolefin resin (d2) is a polyolefin modified with an unsaturated carboxylic acid or a derivative thereof. The acid-modified polyolefin resin (d2) increases adhesion between the base polymer (D) and the halogen-free flame retardant (E) and imparts fuel resistance and cold resistance to the flame-retardant resin composition.

Examples of polyolefin material of the acid-modified polyolefin resin (d2) include very low-density polyethylene, ethylene-methyl acrylate copolymer, ethylene-ethyl acrylate copolymer, ethylene-butene-1 copolymer, ethylene-hexene-1 copolymer and ethylene-octene-1 copolymer, etc. Meanwhile, examples of acid used for modifying polyolefin include maleic acid, maleic acid anhydride and fumaric acid, etc. Such acid-modified polyolefin resins (d2) may be used alone or in combination of two or more.

The acid-modified polyolefin resin (d2) has a glass-transition temperature (Tg) of not more than −55° C. Use of the acid-modified polyolefin resin (d2) having Tg of not more than −55° C. lowers the Tg of the base polymer and thus allows the outer layer 12b to be prevented from cracking under the low temperature environment. In other words, it is possible to improve cold resistance of the outer layer 12b.

VA Content in Base Polymer (D)

The base polymer (D) contains the EVA (d1) and thus contains vinyl acetate (VA) component derived from the EVA (d1). The amount of vinyl acetate component (VA content) in the base polymer is calculated by the following formula (1) when the EVA (d1) comprises 1 or 2 or 3 . . . or k . . . or n types of EVAs.

(VA content in Base polymer)=Σₖ₌₁ⁿXₖYₖ (1)

In the formula (1), Xk is the VA content (mass %) in EVA type-k, Yk is the percentage of the EVA type-k in the entire base polymer and k is a natural number.

In detail, the VA content in the base polymer (D) of, e.g., below-described Example 1, is calculated as follows. In Example 1, 20% of the base polymer (D) is an EVA with a VA content of 14 mass %, 50% is an EVA with a VA content of 46 mass % and 30% is an acid-modified polyolefin resin (in total, 100%). Therefore, when plugging numbers into the formula, the VA content in the base polymer (D) of Example 1 is 25.8 mass % (=14×0.2+46×0.5).

The VA content in the base polymer (D) is not less than 25 mass % and not more than 50 mass %. When the VA content in the base polymer (D) is less than 25 mass %, the polarity of the base polymer (D) is excessively low and it is thus difficult to satisfy flame retardant requirement for the outer layer 12b. On the other hand, when the VA content is more than 50 mass %, the polarity of the base polymer (D) is high and it is thus not possible to prevent blocking of the halogen-free resin composition.

The VA content in the base polymer (D) can be appropriately changed by adjusting a ratio (a mass ratio) of the EVA (d1) containing VA to the acid-modified polyolefin resin (d2). The ratio can be any ratio as long as the VA content in the base polymer (D) falls within a range of not less than 25 mass % and not more than 50 mass %. Exemplarily, the ratio of the EVA (d1) to the acid-modified polyolefin resin (d2) is 70:30 to 99:1.

When the mass ratio of the EVA (d1) is less than 70, the low polarity of the base polymer (D) may cause a decrease in fuel resistance of the outer layer 12b. On the other hand, when the mass ratio of the EVA (d1) is more than 99, a glass-transition temperature of the base polymer (D) is increased due to an increase in polarity of the base polymer (D) and cold resistance of the outer layer 12b may thus decrease.

When the mass ratio of the acid-modified polyolefin resin (d2) is less than 1, the effect of the acid-modified polyolefin resin (d2) is not obtained and fuel resistance and cold resistance may thus decrease. On the other hand, when the mass ratio of the acid-modified polyolefin resin (d2) is more than 30, adhesion between the base polymer (D) and the halogen-free flame retardant (E) is excessively increased and mechanical strength of the outer layer 12b may thus decrease.

The base polymer (D) may contain another polymer other than the EVA (d1) and the acid-modified polyolefin resin (d2). The amount of the other polymer contained in the base polymer (D) is not less than 0 mass % and not more than 10 mass %, exemplarily not less than 0 mass % and not more than 5 mass %.

Halogen-Free Flame Retardant (E)

As the halogen-free flame retardant (E), it is possible to use a metal hydroxide etc. In heating the outer layer 12b, the metal hydroxide causes decomposition and dehydration of the outer layer 12b and the released water decreases the temperature of the outer layer 12b and prevents burning thereof. As the metal hydroxide, it is possible to use, e.g., magnesium hydroxide, aluminum hydroxide, calcium hydroxide, and these metal hydroxides with dissolved nickel. These halogen-free flame retardants (E) can be used alone or in a combination of two or more. Of those, at least one of magnesium hydroxide and aluminum hydroxide is exemplarily used. It is because endothermic quantity thereof at the time of decomposition is 1500 to 1600 J/g which is higher than that of calcium hydroxide (1000 J/g).

From the viewpoint of controlling mechanical characteristics (a balance between tensile strength and elongation) of the outer layer 12b, it is exemplary that the halogen-free flame retardant (E) be surface-treated with, e.g., a silane coupling agent, a titanate-based coupling agent, fatty acid such as stearic acid, fatty acid salt such as stearate, or fatty acid metal such as calcium stearate.

In the flame-retardant resin composition, the halogen-free flame retardant (E) is contained in an amount of not less than 100 parts by mass and not more than 250 parts by mass with respect to 100 parts by mass of the base polymer (D). If the amount of the halogen-free flame retardant (E) is less than 100 parts by mass, flame retardancy of the outer layer 12b decreases. On the other hand, if more than 250 parts by mass, mechanical characteristics of the outer layer 12b decrease and elongation percentage is reduced.

Other Additives

A cross-linking agent or a crosslinking aid is exemplarily added to the flame-retardant resin composition for cross-linking thereof. The cross-linking method is, e.g., a radiation-crosslinking method in which cross-linking is performed after molding the flame-retardant resin composition into the outer layer 12b by exposure to an electron beam or radiation, etc., or a chemical cross-linking method in which the insulating cover layer 12 is cross-linked by heating. In case of using the radiation-crosslinking method, it is exemplary that the flame-retardant resin composition contain a crosslinking aid. As the crosslinking aid, it is possible to use, e.g., trimethylolpropane triacrylate (TMPT) and triallyl isocyanurate (TAIC (trademark)), etc. In case of using the chemical cross-linking method, it is exemplary that the flame-retardant resin composition contain a cross-linking agent. As the cross-linking agent, it is possible to use, e.g., organic peroxides such as 1,3-bis(2-t-butylperoxyisopropyl)benzene and dicumyl peroxide (DCP).

The flame-retardant resin composition, if necessary, may also contain a flame-retardant aid, an antioxidant, a lubricant, a softener, a plasticizer, an inorganic filler, a compatibilizing agent, a stabilizer, carbon black and a colorant, etc. It is possible to add these additives within a range not impairing characteristics of the flame-retardant resin composition.

### Effects of the Embodiment of the Invention

The present embodiment achieves one or plural effects described below.

(a) In the present embodiment, the inner layer 12a of the insulating cover layer 12 is formed of a halogen-free resin composition in which the base polymer (A) contains the first ethylene-α-olefin copolymer (a1) having a MFR of 1 to 5 g/10 min and the second ethylene-α-olefin copolymer (a2) having a MFR of not less than 30 g/10 min. The first copolymer (a1) having a relatively low MFR has a high molecular weight and is excellent in mechanical strength. The second copolymer (a2) having a relatively high MFR has a low molecular weight and is excellent in flexibility. Therefore, it is possible to form the inner layer 12a having a good balance between mechanical strength and flexibility by using the base polymer (A) containing the first copolymer (a1) and the second copolymer (a2).

(b) The inner layer 12a is formed so that the ratio of the first copolymer (a1) to the second copolymer (a2) is 50:50 to 90:10. This ratio allows the inner layer 12a to have excellent mechanical strength and flexibility.

(c) The density of the first copolymer (a1) is set to be not less than 0.864 g/cm³ and not more than 0.890 g/cm³. The density allows the inner layer 12a to have high mechanical strength without impairing flexibility.

(d) The first ethylene-α-olefin copolymer (a1) and the second ethylene-α-olefin copolymer (a2) are hydrophobic non-polar rubbers. By using the hydrophobic rubbers to form the inner layer 12a, it is possible to prevent insulation properties of the inner layer 12a (and electrical characteristics) from deteriorating when the insulated wire 1 is submerged in water.

(e) The melting point of the first copolymer (a1) is set to be not more than 90° C. and that of the second copolymer (a2) is set to be not more than 80° C. Thus, it is possible to reduce the heating temperature for melting and kneading the halogen-free resin composition. Thus, scorching (unintended cross-linking) of the halogen-free resin composition caused by increasing the heating temperature is prevented, resulting in that a decrease in extrusion processability of the halogen-free resin composition due to scorching is suppressed. As a result, it is possible to form the flat and smooth inner layer 12a having a good appearance.

(f) The melting point of the second copolymer (a2) is set to be not less than 55° C. If it is set to be a lower melting point, the second copolymer (a2) with a low-molecular-weight component may exhibit tackiness and cause blocking of the halogen-free resin composition. In the present embodiment, the second copolymer (a2) having a melting point of not less than 55° C. can prevent the blocking of the halogen-free resin composition. The halogen-free resin composition containing the second copolymer (a2) having a melting point of not less than 55° C. is less likely to block even when processed into pellets and is thus excellent in handling properties. Therefore, it is possible to form the inner layer 12a with high productivity.

(g) The inner layer 12a is formed of a halogen-free resin composition containing the inorganic filler (B). The inorganic filler (B) can reduce the amount of toxic gas (carbon monoxide) produced when the inner layer 12a is burnt.

(h) The inorganic filler (B) is contained in an amount of not less than 80 parts by mass and not more than 150 parts by mass with respect to 100 parts by mass of base polymer (A). The inorganic filler (B) added in such an amount allows a decrease in flexibility of the inner layer 12a to be suppressed and also the amount of produced toxic gas to be further reduced.

(i) The average particle size of the inorganic filler (B) is set to be not less than 0.8 μm and not more than 2.5 μm. Setting the average particle size to not less than 0.8 μm allows water to be prevented from permeating the inner layer 12a and it is thereby possible to suppress deterioration in electric characteristics when the insulated wire 1 is submerged in water. Meanwhile, setting the average particle size to not more than 2.5 μm allows the amount of toxic gas produced to be reduced without impairing mechanical strength of the inner layer 12a.

(j) In the present embodiment, the outer layer 12b of the insulating cover layer 12 is formed of a halogen-free flame-retardant resin composition in which the base polymer (D) contains the EVA (d1) including an EVA having a melting point of not less than 70° C. and the acid-modified polyolefin resin (d2) so that the VA content in the base polymer (D) is not more than 50 mass %. The EVA having a melting point of not less than 70° C. has high crystallinity which does not allow fuel etc., to easily penetrate between molecules, hence, excellent in fuel resistance. Fuel resistance decreases when the VA content in the base polymer (D) is not more than 50 mass % but the decrease in fuel resistance is compensated by using the EVA having a melting point of not less than 70° C. Therefore, it is possible to form the outer layer 12b which is excellent in fuel resistance and is less likely to deteriorate even under contact with fuel.

(k) The VA content in the base polymer (D) is set to be not less than 25 mass %. Thus, polarity of the base polymer (D) is enough high to improve flame retardancy of the outer layer 12b.

(l) In the halogen-free resin composition constituting the outer layer 12b, the VA content in the base polymer is not more than 50 mass %. Thus, polarity of the base polymer (D) is enough low to prevent blocking of the halogen-free flame-retardant resin composition. In addition, since a highly crystalline EVA having a melting point of not less than 70° C. is used as the EVA (d1), blocking of the halogen-free flame-retardant resin composition is further prevented. Such a halogen-free flame-retardant resin composition is less likely to block even when processed into pellets and is thus excellent in handling properties. Therefore, it is possible to form the outer layer 12b with high productivity.

(m) The halogen-free flame retardant (E) is contained in an amount of not less than 100 parts by mass and not more than 250 parts by mass with respect to 100 parts by mass of the base polymer (D). The halogen-free flame retardant (E) contained in such an amount allows flame retardancy to be improved without impairing mechanical strength (tensile strength and elongation) of the outer layer 12b.

(n) The acid-modified polyolefin resin (d2) has a glass-transition temperature of not more than −55° C. Such an acid-modified polyolefin resin (d2) lowers the glass-transition temperature of the base polymer (D) and thus allows cold resistance of the outer layer 12b to be improved.

(o) The ratio of the EVA (d1) to the acid-modified polyolefin resin (d2) is set to be 70:30 to 99:1. This ratio allows fuel resistance and cold resistance to be improved in a well-balanced manner without decreasing mechanical strength of the outer layer 12b.

(p) Since the outer layer 12b does not contain halogen elements, halogen gas is not produced when the outer layer 12b is burnt.

(q) The insulated wire 1 in the present embodiment is provided with the insulating cover layer 12 formed by laminating the inner layer 12a having the effects (a) to (i) and the outer layer 12b having the effects (j) to (p). Therefore, the insulated wire 1 is excellent in various characteristics and can be used in, e.g., rolling stocks, automobiles and robots, etc.

### Other Embodiments of the Invention

Although one embodiment of the invention has been described in detail, the invention is not to be limited thereto and modifications can be appropriately implemented without departing from the gist of the invention.

Although the insulating cover layer 12 having the inner layer 12a and the outer layer 12b has been explained in the embodiment described above, the invention is not limited thereto. In the embodiment, the number of the layers constituting the insulating cover layer 12 is not limited to two as long as the inner layer 12a and the outer layer 12b are included, and the insulating cover layer 12 may have another insulation layer in addition to the inner layer 12a and the outer layer 12b. For example, the other insulation layer may be provided between the conductor and the inner layer 12a, or between the inner layer 12a and the outer layer 12b.

When forming the inner layer 12a and the outer layer 12b, respective materials may be extruded in separate processes or may be extruded simultaneously.

The other insulation layer only needs to be formed of a material having insulation properties and is formed of, e.g., a polyolefin resin or a rubber material.

As the polyolefin resin, it is possible to use, e.g., low-density polyethylene, ethylene vinyl acetate copolymer, ethylene ethyl acrylate copolymer, ethylene methyl acrylate copolymer, ethylene-glycidyl methacrylate copolymer and maleic anhydride polyolefin, etc. These polyolefin resins can be used alone or in combination of two or more.

As the rubber material, it is possible to use, e.g., ethylene-propylene copolymer rubber (EPR), ethylene-propylene-diene terpolymer rubber (EPDM), acrylonitrile butadiene rubber (NBR), hydrogenated NBR (HNBR), acrylic rubber, ethylene-acrylic ester copolymer rubber, ethylene-octene copolymer rubber (EOR), ethylene-vinyl acetate copolymer rubber, ethylene-butene-1 copolymer rubber (EBR), butadiene-styrene copolymer rubber (SBR), isobutylene-isoprene copolymer rubber (IIR), block copolymer rubber having a polystyrene block, urethane rubber and phosphazene rubber, etc. These rubber materials can be used alone or in combination of two or more.

The insulated wire 1, if necessary, may be additionally provided with a separator or a braided layer, etc.

### EXAMPLES

Next, the invention will be further specifically described in reference to Examples. It should be noted that the following examples are not intended to limit the invention.

The materials used to form the halogen-free resin composition for the inner layer are listed below.

The following were used as the first copolymer (a1).
Ethylene-α-olefin copolymer (density ρ: 0.864 g/cm³, MFR: 3.6 g/10 min, melting point Tm: less than 50° C.): TAFMER A-4050S, manufactured by Mitsui Chemicals, Inc.
Ethylene-α-olefin copolymer (density ρ: 0.870 g/cm³, MFR: 1.2 g/10 min, melting point Tm: 55° C.): TAFMER A-1070S, manufactured by Mitsui Chemicals, Inc.
Ethylene-α-olefin copolymer (density ρ: 0.890 g/cm³, MFR: 3.2 g/10 min, melting point Tm: 75° C.): Excellen FX357, manufactured by Sumitomo Chemical Co., Ltd.
Ethylene-α-olefin copolymer (density ρ: 0.870 g/cm³, MFR: 1.0 g/10 min, melting point Tm: 64° C.): Engage 8100, manufactured by DuPont Dow Elastomers
Ethylene-α-olefin copolymer (density ρ: 0.870 g/cm³, MFR: 5.0 g/10 min, melting point Tm: 68° C.): Engage 8200, manufactured by DuPont Dow Elastomers
Ethylene-α-olefin copolymer (density ρ: 0.885 g/cm³, MFR: 1.0 g/10 min, melting point Tm: 86° C.): Engage 8003, manufactured by DuPont Dow Elastomers
Ethylene-α-olefin copolymer (density ρ: 0.862 g/cm³, MFR: 1.2 g/10 min, melting point Tm: less than 50° C.): TAFMER A-1050S, manufactured by Mitsui Chemicals, Inc.
Ethylene-α-olefin copolymer (density ρ: 0.893 g/cm³, MFR: 3.6 g/10 min, melting point Tm: 61° C.): TAFMER A-4090S, manufactured by Mitsui Chemicals, Inc.
Ethylene-α-olefin copolymer (density ρ: 0.868 g/cm³, MFR: 0.5 g/10 min, melting point Tm: 67° C.): Engage 8150, manufactured by DuPont Dow Elastomers
Ethylene-α-olefin copolymer (density ρ: 0.880 g/cm³, MFR: 8.0 g/10 min, melting point Tm: 64° C.): Excellen CX4002, manufactured by Sumitomo Chemical Co., Ltd.
Ethylene-α-olefin copolymer (density ρ: 0.898 g/cm³, MFR: 3.5 g/10 min, melting point Tm: 93° C.): KERNEL KF360T, manufactured by Japan Polyethylene Corporation

The following were used as the second copolymer (a2).
Ethylene-α-olefin copolymer (density ρ: 0.880 g/cm³, MFR: 30 g/10 min, melting point Tm: 66° C.): Excellen FX551, manufactured by Sumitomo Chemical Co., Ltd.
Ethylene-α-olefin copolymer (density ρ: 0.870 g/cm³, MFR: 35 g/10 min, melting point Tm: 55° C.): TAFMER A-350705, manufactured by Mitsui Chemicals, Inc.
Ethylene-α-olefin copolymer (density ρ: 0.890 g/cm³, MFR: 75 g/10 min, melting point Tm: 79° C.): Excellen FX551, manufactured by Sumitomo Chemical Co., Ltd.
Ethylene-α-olefin copolymer (density ρ: 0.878 g/cm³, MFR: 16 g/10 min, melting point Tm: 53° C.): Excellen CX5505, manufactured by Sumitomo Chemical Co., Ltd.
Ethylene-α-olefin copolymer (density ρ: 0.864 g/cm³, MFR: 3.6 g/10 min, melting point Tm: less than 50° C.): TAFMER A-4050S, manufactured by Mitsui Chemicals, Inc.

The following were used as the inorganic filler (B).
Baked clay (average particle size: 1.4 μm): TRANSLINK 37, manufactured by Hayashi-Kasei Co., Ltd.
Baked clay (average particle size: 0.8 μm): TRANSLINK 77, manufactured by Hayashi-Kasei Co., Ltd.
Talc (average particle size: 1.0 μm): D-1000, manufactured by Nippon Talc Co., Ltd.
Talc (average particle size: 2.5 μm): SG-95, manufactured by Nippon Talc Co., Ltd.
Calcium carbonate (average particle size: 1.8 μm): SOFTON 1200, manufactured by Bihoku Funka Kogyo Co., Ltd.

The following was used as the cross-linking agent (C).
Organic peroxide: PERBUTYL P, manufactured by NOF Corporation

The materials used to form the halogen-free flame-retardant resin composition for the outer layer are listed below.

The following were used as the EVA (d1).
EVA (Tm: 89° C., MFR: 15 g/10 min, VA content: 14 mass %): EVAFLEX EV550, manufactured by DuPont-Mitsui Polychemicals Co., Ltd.
EVA (Tm: 72° C., MFR: 6 g/10 min, VA content: 28 mass %): EVAFLEX EV260, manufactured by DuPont-Mitsui Polychemicals Co., Ltd.
EVA (Tm: less than 70° C., MFR: 100 g/10 min, VA content: 46 mass %): EVAFLEX EV45X, manufactured by DuPont-Mitsui Polychemicals Co., Ltd.
EVA (Tm: less than 70° C., MFR: 2.5 g/10 min, VA content: 46 mass %): EVAFLEX EV45LX, manufactured by DuPont-Mitsui Polychemicals Co., Ltd.
EVA (Tm: 62° C., MFR: 1 g/10 min, VA content: 33 mass %): EVAFLEX EV170, manufactured by DuPont-Mitsui Polychemicals Co., Ltd.
EVA (Tm: less than 70° C., MFR: 5.1 g/10 min, VA content: 80 mass %): Levapren 800, manufactured by LANXESS

The following were used as the acid-modified polyolefin resin (d2).
Acid-modified polyolefin resin (Tm: 66° C., Tg: not more than −55° C.): TAFMER MH-7020, manufactured by Mitsui Chemicals, Inc.
Acid-modified polyolefin resin (Tm: 66° C., Tg: not more than −50° C.): OREVAC G 18211, manufactured by ARKEMA

The following were used as the halogen-free flame retardant (E).
Magnesium hydroxide (treated with silane): MAGNIFIN H10A, manufactured by Albemarle Corporation
Magnesium hydroxide (treated with fatty acid): MAGNIFIN H10C, manufactured by Albemarle Corporation
Aluminum hydroxide (treated with silane): BF013STV, manufactured by Nippon Light Metal Company, Ltd.
Aluminum hydroxide (treated with fatty acid): HIGILITE H42S, manufactured by Showa Denko K. K.

The following was used as the other additive.
Trimethylolpropane triacrylate (crosslinking aid): TMPT, manufactured by Shin-Nakamura Chemical, Co., Ltd.

### (1) Preparation of Halogen-Free Resin Composition for Inner Layer

Firstly, components shown in Table 1 below were mixed and kneaded by a 25-liter kneader at a preset temperature of 50° C. Each mixture was kneaded until the temperature reached 150° C. by self-heating and was then pelletized, thereby preparing halogen-free resin compositions for inner layer in Examples 1 to 16. Likewise, halogen-free resin compositions for inner layer in Comparative Examples 1 to 11 were prepared by mixing components shown in Table 2 below.

TABLE 1

| | | | Examples | | | | | | | |
|---|---|---|---|---|---|---|---|---|---|---|
| | | | 1 | 2 | 3 | 4 | 5 | 6 | 7 | 8 |
| Base | First | Ethylene-α-olefin | — | — | — | — | — | 50 | — | — |
| polymer (A) | copolymer | (ρ: 0.864, MFR: 3.6, Tm: <50) | | | | | | | | |
| | (a1) | Ethylene-α-olefin | — | — | — | — | — | — | — | — |
| | | (ρ: 0.870, MFR: 1.2, Tm: 55) | | | | | | | | |
| | | Ethylene-α-olefin | — | — | — | — | 50 | — | — | — |
| | | (ρ: 0.890, MFR: 3.2, Tm: 75) | | | | | | | | |
| | | Ethylene-α-olefin | 90 | 90 | 90 | 50 | — | — | — | — |
| | | (ρ: 0.870, MFR: 1.0, Tm: 64) | | | | | | | | |
| | | Ethylene-α-olefin | — | — | — | — | — | — | — | 50 |
| | | (ρ: 0.870, MFR: 5.0, Tm: 68) | | | | | | | | |
| | | Ethylene-α-olefin | — | — | — | — | — | — | 50 | — |
| | | (ρ: 0.885, MFR: 1.0, Tm: 86) | | | | | | | | |
| | Second | Ethylene-α-olefin | — | — | — | — | — | — | — | — |
| | copolymer | (ρ: 0.880, MFR: 30, Tm: 66) | | | | | | | | |
| | (a2) | Ethylene-α-olefin | 10 | 10 | 10 | 50 | — | 50 | — | — |
| | | (ρ: 0.870, MFR: 35, Tm: 55) | | | | | | | | |
| | | Ethylene-α-olefin | — | — | — | — | 50 | — | 50 | 50 |
| | | (ρ: 0.890, MFR: 75, Tm: 79) | | | | | | | | |
| Inorganic | | Baked clay (particle size: 1.4 μm) | — | — | — | — | — | — | — | — |
| filler (B) | | Baked clay (particle size: 0.8 μm) | 80 | 120 | 150 | 120 | 120 | 120 | 120 | 120 |
| | | Talc (particle size: 1.0 μm) | — | — | — | — | — | — | — | — |
| | | Talc (particle size: 2.5 μm) | — | — | — | — | — | — | — | — |
| | | Calcium carbonate | — | — | — | — | — | — | — | — |
| | | (particle size: 1.8 μm): | | | | | | | | |
| Cross-linking | | Organic peroxide | 1.5 | 1.5 | 1.5 | 1.5 | 1.5 | 1.5 | 1.5 | 1.5 |
| agent (C) | | | | | | | | | | |
| | | | Examples | | | | | | | |
| | | | 9 | 10 | 11 | 12 | 13 | 14 | 15 | 16 |
| Base | First | Ethylene-α-olefin | — | — | 30 | 30 | 30 | 30 | 30 | 30 |
| polymer (A) | copolymer | (ρ: 0.864, MFR: 3.6, Tm: <50) | | | | | | | | |
| | (a1) | Ethylene-α-olefin | — | 50 | 60 | 60 | 60 | 60 | 60 | 60 |
| | | (ρ: 0.870, MFR: 1.2, Tm: 55) | | | | | | | | |
| | | Ethylene-α-olefin | — | — | — | — | — | — | — | — |
| | | (ρ: 0.890, MFR: 3.2, Tm: 75) | | | | | | | | |
| | | Ethylene-α-olefin | 50 | — | — | — | — | — | — | — |
| | | (ρ: 0.870, MFR: 1.0, Tm: 64) | | | | | | | | |
| | | Ethylene-α-olefin | — | — | — | — | — | — | — | — |
| | | (ρ: 0.870, MFR: 5.0, Tm: 68) | | | | | | | | |
| | | Ethylene-α-olefin | — | — | — | — | — | — | — | — |
| | | (ρ: 0.885, MFR: 1.0, Tm: 86) | | | | | | | | |
| | Second | Ethylene-α-olefin | 50 | — | — | — | — | — | — | 5 |
| | copolymer | (ρ: 0.880, MFR: 30, Tm: 66) | | | | | | | | |
| | (a2) | Ethylene-α-olefin | — | 50 | 10 | 10 | 10 | 10 | 10 | 5 |
| | | (ρ: 0.870, MFR: 35, Tm: 55) | | | | | | | | |
| | | Ethylene-α-olefin | — | — | — | — | — | — | — | — |
| | | (ρ: 0.890, MFR: 75, Tm: 79) | | | | | | | | |

| | | | | | | | | | |
|---|---|---|---|---|---|---|---|---|---|
| Inorganic | Baked clay (particle size: 1.4 μm) | — | — | — | 120 | — | — | — | — |
| filler (B) | Baked clay (particle size: 0.8 μm) | 120 | 120 | 120 | — | — | — | — | 120 |
| | Talc (particle size: 1.0 μm) | — | — | — | — | 120 | — | — | — |
| | Talc (particle size: 2.5 μm) | — | — | — | — | — | 120 | — | — |
| | Calcium carbonate | — | — | — | — | — | — | 120 | — |
| | (particle size: 1.8 μm): | | | | | | | | |
| Cross-linking | Organic peroxide | 1.5 | 1.5 | 1.5 | 1.5 | 1.5 | 1.5 | 1.5 | 1.5 |
| agent (C) | | | | | | | | | |

TABLE 2

| | | | Comparative Examples | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Base | First | Ethylene-α-olefin | 100 | 40 | 50 | 50 | — | — | — | — | — | 50 | 50 |
| polymer | copoly- | (ρ: 0.870, MFR: 1.0, | | | | | | | | | | | |
| (A) | mer | Tm: 64) | | | | | | | | | | | |
| | (a1) | Ethylene-α-olefin | — | — | — | — | 50 | — | — | — | — | — | — |
| | | (ρ: 0.862, MFR: 1.2, | | | | | | | | | | | |
| | | Tm: <50) | | | | | | | | | | | |
| | | Ethylene-α-olefin | — | — | — | — | — | 50 | — | — | — | — | — |
| | | (ρ: 0.893, MFR: 3.6, | | | | | | | | | | | |
| | | Tm: 61) | | | | | | | | | | | |
| | | Ethylene-α-olefin | — | — | — | — | — | — | 50 | — | — | — | — |
| | | (ρ: 0.868, MFR: 0.5, | | | | | | | | | | | |
| | | Tm: 67) | | | | | | | | | | | |
| | | Ethylene-α-olefin | — | — | — | — | — | — | — | 50 | — | — | — |
| | | (ρ: 0.880, MFR: 8.0, | | | | | | | | | | | |
| | | Tm: 64) | | | | | | | | | | | |
| | | Ethylene-α-olefin | — | — | — | — | — | — | — | — | 50 | — | — |
| | | (ρ: 0.898, MFR: 3.5, | | | | | | | | | | | |
| | | Tm: 93) | | | | | | | | | | | |
| | Second | Ethylene-α-olefin | — | 60 | 50 | 50 | 50 | 50 | 50 | 50 | 50 | — | — |
| | copoly- | (ρ: 0.870, MFR: 35, | | | | | | | | | | | |
| | mer | Tm: 55) | | | | | | | | | | | |
| | (a2) | Ethylene-α-olefin | — | — | — | — | — | — | — | — | — | 50 | — |
| | | (ρ: 0.878, MFR: 16, | | | | | | | | | | | |
| | | Tm: 53) | | | | | | | | | | | |
| | | Ethylene-α-olefin | — | — | — | — | — | — | — | — | — | — | 50 |
| | | (ρ: 0.864, MFR: 3.6, | | | | | | | | | | | |
| | | Tm: <50) | | | | | | | | | | | |

| | | | | | | | | | | | | |
|---|---|---|---|---|---|---|---|---|---|---|---|---|
| Inorganic filler | Baked clay (particle size: | 120 | 120 | 70 | 160 | 120 | 120 | 120 | 120 | 120 | 120 | 120 |
| (B) | 0.8 μm) | | | | | | | | | | | |
| Cross-linking | Organic peroxide | 1.5 | 1.5 | 1.5 | 1.5 | 1.5 | 1.5 | 1.5 | 1.5 | 1.5 | 1.5 | 1.5 |
| agent (C) | | | | | | | | | | | | |

### (2) Preparation of Halogen-Free Flame-Retardant Resin Composition for Outer Layer

Next, components shown in Table 3 below were mixed and kneaded by a pressure kneader at a start temperature of 50° C. and an end temperature of 200° C. Each mixture was pelletized after kneading, thereby preparing halogen-free flame-retardant resin compositions for outer layer in Examples 1 to 16. Likewise, halogen-free flame-retardant resin compositions for outer layer in Comparative Examples 1 to 11 were prepared by mixing components shown in Table 4 below.

TABLE 3

| | | | Examples | | | | | | | |
|---|---|---|---|---|---|---|---|---|---|---|
| | | | 1 | 2 | 3 | 4 | 5 | 6 | 7 | 8 |
| Base polymer (D) | EVA (d1) | EVA | 20 | 64 | — | 20 | — | 20 | 20 | 64 |
| | | (Tm: 89° C., MFR: 15 g/10 min, | | | | | | | | |
| | | VA content: 14 mass %) | | | | | | | | |
| | | EVA | — | — | 70 | — | 5 | — | — | — |
| | | (Tm: 72° C., MFR: 6 g/10 min, | | | | | | | | |
| | | VA content: 28 mass %) | | | | | | | | |
| | | EVA | 50 | 35 | 15 | 50 | — | 50 | 50 | 35 |
| | | (Tm: less than 70° C., MFR: 100 g/ | | | | | | | | |
| | | 10 min, VA content: 46 mass %) | | | | | | | | |
| | | EVA | — | — | — | — | 94 | — | — | — |
| | | (Tm: less than 70° C., MFR: 2.5 g/ | | | | | | | | |
| | | 10 min, VA content: 46 mass %) | | | | | | | | |
| | Acid-modified | Acid-modified polyolefin | 30 | 1 | 15 | 30 | 1 | 30 | 30 | 1 |
| | polyolefin resin | (Tm: 66° C., Tg: not more than | | | | | | | | |
| | (d2) | −55° C.) | | | | | | | | |
| Halogen-free flame | | Silane-treated magnesium | 80 | 80 | 80 | 50 | 100 | — | 80 | 80 |
| retardant (E) | | hydroxide | | | | | | | | |
| | | Fatty acid-treated magnesium | 120 | 120 | 120 | 50 | 150 | — | 120 | 120 |
| | | hydroxide | | | | | | | | |
| | | Silane-treated aluminum | — | — | — | — | — | 100 | — | — |
| | | hydroxide | | | | | | | | |
| | | Fatty acid-treated aluminum | — | — | — | — | — | 80 | — | — |
| | | hydroxide | | | | | | | | |
| Crosslinking aid | | Trimethylolpropane triacrylate | 4 | 4 | 4 | 4 | 4 | 4 | 4 | 4 |
| VA content (mass %) in Base polymer | | | 25.8 | 25.1 | 26.5 | 25.8 | 44.6 | 25.8 | 25.8 | 25.1 |
| | | | Examples | | | | | | | |
| | | | 9 | 10 | 11 | 12 | 13 | 14 | 15 | 16 |
| Base polymer (D) | EVA (d1) | EVA | — | 20 | — | 20 | 20 | 64 | — | 20 |
| | | (Tm: 89° C., MFR: 15 g/10 min, | | | | | | | | |
| | | VA content: 14 mass %) | | | | | | | | |
| | | EVA | 70 | — | 5 | — | — | — | 70 | — |
| | | (Tm: 72° C., MFR: 6 g/10 min, | | | | | | | | |
| | | VA content: 28 mass %) | | | | | | | | |
| | | EVA | 15 | 50 | — | 50 | 50 | 35 | 15 | 50 |
| | | (Tm: less than 70° C., MFR: 100 g/ | | | | | | | | |
| | | 10 min, VA content: 46 mass %) | | | | | | | | |
| | | EVA | — | — | 95 | — | — | — | — | — |
| | | (Tm: less than 70° C., MFR: 2.5 g/ | | | | | | | | |
| | | 10 min, VA content: 46 mass %) | | | | | | | | |
| | Acid-modified | Acid-modified polyolefin | 15 | 30 | 1 | 30 | 30 | 1 | 15 | 30 |
| | polyolefin resin | (Tm: 66° C., Tg: not more than | | | | | | | | |
| | (d2) | −55° C.) | | | | | | | | |

| | | | | | | | | | |
|---|---|---|---|---|---|---|---|---|---|
| Halogen-free flame | Silane-treated magnesium | 80 | 50 | 100 | — | 80 | 80 | 80 | 50 |
| retardant (E) | hydroxide | | | | | | | | |
| | Fatty acid-treated magnesium | 120 | 50 | 150 | — | 120 | 120 | 120 | 50 |
| | hydroxide | | | | | | | | |
| | Silane-treated aluminum | — | — | — | 100 | — | — | — | — |
| | hydroxide | | | | | | | | |
| | Fatty acid-treated aluminum | — | — | — | 80 | — | — | — | — |
| | hydroxide | | | | | | | | |
| Crosslinking aid | Trimethylolpropane triacrylate | 4 | 4 | 4 | 4 | 4 | 4 | 4 | 4 |

| | | | | | | | | |
|---|---|---|---|---|---|---|---|---|
| VA content (mass %) in Base polymer | 26.5 | 25.8 | 44.6 | 25.8 | 25.8 | 25.1 | 26.5 | 25.8 |

TABLE 4

| | | | Comparative Examples | | | | | |
|---|---|---|---|---|---|---|---|---|
| | | | 1 | 2 | 3 | 4 | 5 | 6 |
| Base polymer (D) | EVA (d1) | EVA | 69 | — | 10 | — | 64 | 64 |
| | | (Tm: 89° C., MFR: 15 g/10 min, | | | | | | |
| | | VA content: 14 mass %) | | | | | | |
| | | EVA | — | — | — | 100 | — | — |
| | | (Tm: 72° C., MFR: 6 g/10 min, | | | | | | |
| | | VA content: 28 mass %) | | | | | | |
| | | EVA | — | — | — | — | — | — |
| | | (Tm: 62° C., MFR: 1 g/10 min, | | | | | | |
| | | VA content: 33 mass %) | | | | | | |
| | | EVA | 30 | 10 | — | — | 35 | 35 |
| | | (Tm: less than 70° C., MFR: 100 g/ | | | | | | |
| | | 10 min, VA content: 46 mass %) | | | | | | |
| | | EVA | — | 60 | 55 | — | — | — |
| | | (Tm: less than 70° C., MFR: 5.1 g/ | | | | | | |
| | | 10 min, VA content: 80 mass %) | | | | | | |
| | Acid-modified | Acid-modified polyolefin | 1 | 30 | 35 | — | 1 | 1 |
| | polyolefin | (Tm: 66° C., Tg: not more than | | | | | | |
| | resin (d2) | −55° C.) | | | | | | |
| | | Acid-modified polyolefin | — | — | — | — | — | — |
| | | (Tm: 66° C., Tg: −50° C.) | | | | | | |

| | | | | | | | |
|---|---|---|---|---|---|---|---|
| Halogen-free flame | Silane-treated magnesium | 100 | 100 | 100 | 100 | 40 | 110 |
| retardant (E) | hydroxide | | | | | | |
| | Fatty acid-treated magnesium | 100 | 100 | 100 | 100 | 50 | 150 |
| | hydroxide | | | | | | |
| Crosslinking aid | Trimethylolpropane triacrylate | 4 | 4 | 4 | 4 | 4 | 4 |

| | | | | | | |
|---|---|---|---|---|---|---|
| VA content (mass %) in Base polymer | 23.5 | 52.6 | 45.4 | 28 | 25.1 | 25.1 |

| | | | Comparative Examples | | | | |
|---|---|---|---|---|---|---|---|
| | | | 7 | 8 | 9 | 10 | 11 |
| Base polymer (D) | EVA (d1) | EVA | 64 | — | 20 | 20 | 20 |
| | | (Tm: 89° C., MFR: 15 g/10 min, | | | | | |
| | | VA content: 14 mass %) | | | | | |
| | | EVA | — | — | — | — | — |
| | | (Tm: 72° C., MFR: 6 g/10 min, | | | | | |
| | | VA content: 28 mass %) | | | | | |
| | | EVA | — | 90 | — | — | — |
| | | (Tm: 62° C., MFR: 1 g/10 min, | | | | | |
| | | VA content: 33 mass %) | | | | | |
| | | EVA | 35 | — | 50 | 50 | 50 |
| | | (Tm: less than 70° C., MFR: 100 g/ | | | | | |
| | | 10 min, VA content: 46 mass %) | | | | | |
| | | EVA | — | — | — | — | — |
| | | (Tm: less than 70° C., MFR: 5.1 g/ | | | | | |
| | | 10 min, VA content: 80 mass %) | | | | | |
| | Acid-modified | Acid-modified polyolefin | — | — | 30 | 30 | 30 |
| | polyolefin | (Tm: 66° C., Tg: not more than | | | | | |
| | resin (d2) | −55° C.) | | | | | |
| | | Acid-modified polyolefin | 1 | 10 | — | — | — |
| | | (Tm: 66° C., Tg: −50° C.) | | | | | |

| | | | | | | |
|---|---|---|---|---|---|---|
| Halogen-free flame | Silane-treated magnesium | 100 | 100 | 80 | 80 | 80 |
| retardant (E) | hydroxide | | | | | |
| | Fatty acid-treated magnesium | 150 | 100 | 120 | 120 | 120 |
| | hydroxide | | | | | |
| Crosslinking aid | Trimethylolpropane triacrylate | 4 | 4 | 4 | 4 | 4 |

| | | | | | |
|---|---|---|---|---|---|
| VA content (mass %) in Base polymer | 25.1 | 29.7 | 25.8 | 25.8 | 25.8 |

### (3) Manufacture of Insulated Wire

Next, using the prepared materials, each insulated wire was made as follows.

Firstly, the halogen-free resin composition for inner layer was extruded to cover the outer periphery of a conductor by a 4.5-inch continuous vapor crosslinking extruder. Extrusion coating here was performed at a cylinder temperature of 100° C. so that the inner layer has a thickness of 0.45 mm. Then, the inner layer was cross-linked by exposure to high-pressure steam of 1.5 MPa for 3 minutes. Following this, the halogen-free flame-retardant resin composition for outer layer was extruded to cover the outer periphery of the inner layer by a 90-mm extruder at a temperature of 120° C. Extrusion coating here was performed so that an insulated wire has an outer diameter of 4.4 mm. Then, the outer layer was cross-linked by electron beam irradiation of 4 Mrad, thereby making an insulated wire. The conductor used in Examples was a bunch stranded conductor formed by twisting eighty 0.40 mm-diameter tin-plated conductors together.

### (4) Evaluation Method

The inner and outer layers were evaluated by the following methods.

### (4)-1 Evaluation of Inner Layer

### Storage Stability at Room Temperature

Storage stability was evaluated based on whether or not blocking occurred when the halogen-free resin composition for inner layer was stored at room temperature. In detail, two paper bags of 420 mm×820 mm each packed with 20 kg of pelletized halogen-free resin composition for inner layer were stacked and stored in a constant-temperature oven at 40° C. for 240 hours. After that, the pellets were poured on a tray and blocking of the pellets was checked. Pellets without blocking were evaluated as “◯ (good)” and those with blocking were evaluated as “X (bad)”.

Extrusion Processability

Extrusion processability was evaluated based on a wire taking-up speed during when the halogen-free resin composition for inner layer was being extruded from a 4.5-inch continuous vapor crosslinking extruder. It was regarded as “◯” when the wire was taken up at not less than 20 m/min, regarded as “Δ (acceptable)” when the wire was taken up at not less than 1 m/min and less than 20 m/min, and regarded as “X” when the wire couldn't be taken up at all.

Outer Appearance

For outer appearance of the inner layer, the surface of the inner layer was visually checked. The inner layers with smooth surface were evaluated as “◯” and those with rough surface were evaluated as “X”.

Electrical Characteristics

An electrical test was conducted in accordance with EN 50264-3-1, item 7-7 to evaluate electrical characteristics. In detail, a DC stability test was conducted, in which insulated wires were immersed in 3% salt water at a temperature of 85° C. and negative voltage of 4.5 kV and 1.5 kV was applied to the insulated wires. Then, the insulated wires which were not short-circuited at 4.5 kV and 1.5 kV after 10 days were evaluated as “⊚ (excellent)”, those which were short-circuited at 4.5 kV in less than 10 days but not short-circuited at 1.5 kV after 10 days were evaluated as “◯”, and those which were short-circuited at 4.5 kV and 1.5 kV in less than 10 days were evaluated as “X”.

Flexibility

One end of each insulated wire was fixed to a base so that another end projects by 200 cm from the base, and a weight of 5 g was hanged on the other end. Flexibility was evaluated based on the amount of deflection of the insulated wire. The insulated wires with deflection of not less than 100 mm were evaluated as “⊚”, those with deflection of not less than 50 mm and less than 100 mm were evaluated as “◯”, and those with deflection of less than 50 mm were evaluated as “X”.

Mechanical Strength

The inner layers were scraped off and the scraped pieces were stamped out with a No. 6 dumbbell to make test samples. Mechanical strength was evaluated based on tensile strength when the test samples were pulled with a gauge length of 20 mm at a pulling speed of 200 mm/min. The inner layers having a tensile strength of not less than 7 MPa were evaluated as “◯” and those having a tensile strength of less than 7 MPa were evaluated as “X”.

Amount of Produced Carbon Monoxide

The amount of produced carbon monoxide was measured in accordance with EN 50305. The produced amount of not more than 30 m/g was regarded as “◯” and more than 30 m/g was regarded as “X”.

### (4)-2 Evaluation of Outer layer

### Storage Stability at Room Temperature

Storage stability was evaluated based on whether or not blocking occurred when the halogen-free flame-retardant resin composition for outer layer was stored at room temperature. In detail, two paper bags of 420 mm×820 mm each packed with 20 kg of pelletized halogen-free flame-retardant resin composition for outer layer were stacked and stored in a constant-temperature oven at 40° C. for 240 hours. After that, the pellets were poured on a tray and blocking of the pellets was checked. Pellets without blocking were evaluated as “◯” and those with blocking were evaluated as “X”.

Mechanical Strength

The outer layer was peeled off from each obtained insulated wire and was subjected to the tensile test in accordance with EN 60811-1-1, and mechanical strength was evaluated based on tensile strength and elongation. The outer layers having a tensile strength of not less than 10 MPa and elongation of not less than 125% were evaluated as “◯”, and those with values less than 10 MPa and 125% were evaluated as “X”.

Fuel Resistance

For evaluating fuel resistance, the outer layer was peeled off from each obtained insulated wire and was subjected to the fuel resistance test in accordance with EN 60811-1-3. In detail, the outer layer was immersed in fuel-resistance-test oil IRM 903, was heated in a constant-temperature oven at 70° C. for 168 hours and was then left at room temperature for about 16 hours. After that, a tensile test was conducted on the oil-immersed outer layer. Then, measurement was conducted on each outer layer to derive tensile strength retention as a percentage of tensile strength after oil immersion with respect to the initial tensile strength (before oil immersion) and elongation retention as a percentage of elongation after oil immersion with respect to the initial elongation. For tensile strength retention, not less than 70% was regarded as “◯” and less than 70% was regarded as “X”. Meanwhile, for elongation retention, not less than 60% was regarded as “◯” less than 60% was regarded as “X”.

Cold Resistance

The obtained insulated wires were subjected to a bending test at −40° C. in accordance with EN 60811-1-4 8.1 to evaluate cold resistance. The insulated wires without cracks after winding in the bending test were evaluated as “◯” and those with cracks were evaluated as “X”.

Flame Retardancy

The obtained insulated wires were subjected to a vertical flame test in accordance with EN 60332-1-2. Flame retardancy was evaluated based on a distance between a lower edge of an upper support member and an upper edge of the carbonized portion after extinguishing the insulating cover layer in the vertical flame test. The distance of not less than 50 mm was regarded as “◯” and less than 50 mm was regarded as “X”.

### (4)-3 Overall Evaluation

When all characteristics of the inner and outer layers were evaluated as “◯”, the overall evaluation was rated as “◯”. When even one of the characteristics of the inner and outer layers was evaluated as “X”, the overall evaluation was rated as rated as “X”. Table 5 shows the evaluation results of Examples 1 to 16 and Table 6 shows the evaluation results of Comparative Examples 1 to 11.

TABLE 5

| | | | Examples | | | | | | | |
|---|---|---|---|---|---|---|---|---|---|---|
| | | | 1 | 2 | 3 | 4 | 5 | 6 | 7 | 8 |
| Evaluation | Inner layer | Storage stability at room | ◯ | ◯ | ◯ | ◯ | ◯ | ◯ | ◯ | ◯ |
| | | temperature | | | | | | | | |
| | | Extrusion processability | ⊚ | ◯ | ◯ | ◯ | ⊚ | ◯ | ⊚ | ⊚ |
| | | Outer appearance | ◯ | ◯ | ◯ | ◯ | ◯ | ◯ | ◯ | ◯ |
| | | Electrical characteristics | ⊚ | ⊚ | ⊚ | ⊚ | ⊚ | ⊚ | ⊚ | ⊚ |
| | | Flexibility | ⊚ | ⊚ | ⊚ | ⊚ | ⊚ | ⊚ | ⊚ | ⊚ |
| | | Mechanical strength | ◯ | ◯ | ◯ | ◯ | ◯ | ◯ | ◯ | ◯ |
| | | Amount of produced | ◯ | ◯ | ◯ | ◯ | ◯ | ◯ | ◯ | ◯ |
| | | carbon monoxide | | | | | | | | |
| | Outer layer | Storage stability at room | ◯ | ◯ | ◯ | ◯ | ◯ | ◯ | ◯ | ◯ |
| | | temperature | | | | | | | | |
| | | Tensile strength (MPa) | 13.4 | 11.4 | 10.7 | 12.1 | 10.2 | 12.5 | 13.4 | 11.4 |
| | | | ◯ | ◯ | ◯ | ◯ | ◯ | ◯ | ◯ | ◯ |
| | | Elongation (%) | 127 | 317 | 213 | 303 | 125 | 187 | 127 | 317 |
| | | | ◯ | ◯ | ◯ | ◯ | ◯ | ◯ | ◯ | ◯ |

| | | | | | | | | | |
|---|---|---|---|---|---|---|---|---|---|
| Fuel | Tensile | 89 | 70 | 80 | 83 | 79 | 82 | 89 | 70 |
| resistance | strength | ◯ | ◯ | ◯ | ◯ | ◯ | ◯ | ◯ | ◯ |
| | retention (%) | | | | | | | | |
| | Elongation | 95 | 62 | 94 | 92 | 92 | 91 | 95 | 62 |
| | retention (%) | ◯ | ◯ | ◯ | ◯ | ◯ | ◯ | ◯ | ◯ |

| | | Cold resistance | ◯ | ◯ | ◯ | ◯ | ◯ | ◯ | ◯ | ◯ |
|---|---|---|---|---|---|---|---|---|---|---|
| | | Flame retardancy | ◯ | ◯ | ◯ | ◯ | ◯ | ◯ | ◯ | ◯ |
| Overall Evaluation | | | ◯ | ◯ | ◯ | ◯ | ◯ | ◯ | ◯ | ◯ |
| | | | Examples | | | | | | | |
| | | | 9 | 10 | 11 | 12 | 13 | 14 | 15 | 16 |
| Evaluation | Inner layer | Storage stability at room | ◯ | ◯ | ◯ | ◯ | ◯ | ◯ | ◯ | ◯ |
| | | temperature | | | | | | | | |
| | | Extrusion processability | ◯ | ◯ | ◯ | ◯ | ◯ | ◯ | ◯ | ◯ |
| | | Outer appearance | ◯ | ◯ | ◯ | ◯ | ◯ | ◯ | ◯ | ◯ |
| | | Electrical characteristics | ⊚ | ⊚ | ⊚ | ⊚ | ⊚ | ⊚ | ⊚ | ⊚ |
| | | Flexibility | ⊚ | ⊚ | ⊚ | ⊚ | ⊚ | ⊚ | ⊚ | ⊚ |
| | | Mechanical strength | ◯ | ◯ | ◯ | ◯ | ◯ | ◯ | ◯ | ◯ |
| | | Amount of produced | ◯ | ◯ | ◯ | ◯ | ◯ | ◯ | ◯ | ◯ |
| | | carbon monoxide | | | | | | | | |
| | Outer layer | Storage stability at room | ◯ | ◯ | ◯ | ◯ | ◯ | ◯ | ◯ | ◯ |
| | | temperature | | | | | | | | |
| | | Tensile strength (MPa) | 10.7 | 12.1 | 10.2 | 12.5 | 13.4 | 11.4 | 10.7 | 12.1 |
| | | | ◯ | ◯ | ◯ | ◯ | ◯ | ◯ | ◯ | ◯ |
| | | Elongation (%) | 213 | 303 | 125 | 187 | 127 | 317 | 213 | 303 |
| | | | ◯ | ◯ | ◯ | ◯ | ◯ | ◯ | ◯ | ◯ |

| | | | | | | | | | |
|---|---|---|---|---|---|---|---|---|---|
| Fuel | Tensile | 80 | 83 | 79 | 82 | 89 | 70 | 80 | 83 |
| resistance | strength | ◯ | ◯ | ◯ | ◯ | ◯ | ◯ | ◯ | ◯ |
| | retention (%) | | | | | | | | |
| | Elongation | 94 | 92 | 92 | 91 | 95 | 62 | 94 | 92 |
| | retention (%) | ◯ | ◯ | ◯ | ◯ | ◯ | ◯ | ◯ | ◯ |

| | | | | | | | | |
|---|---|---|---|---|---|---|---|---|
| Cold resistance | ◯ | ◯ | ◯ | ◯ | ◯ | ◯ | ◯ | ◯ |
| Flame retardancy | ◯ | ◯ | ◯ | ◯ | ◯ | ◯ | ◯ | ◯ |

| | | | | | | | | |
|---|---|---|---|---|---|---|---|---|
| Overall Evaluation | ◯ | ◯ | ◯ | ◯ | ◯ | ◯ | ◯ | ◯ |

TABLE 6

| | | | Comparative Examples | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Eval- | Inner | Storage stability at | ◯ | ◯ | ◯ | ◯ | ◯ | ◯ | ◯ | ◯ | ◯ | X | X |
| ua- | layer | room temperature | | | | | | | | | | | |
| tion | | Extrusion | ◯ | ◯ | ◯ | ◯ | ◯ | ◯ | X | ◯ | Δ | X | X |
| | | processability | | | | | | | | | | | |
| | | Outer appearance | ◯ | ◯ | ◯ | ◯ | ◯ | ◯ | Impossible | ◯ | X | Impossible | Impossible |
| | | Electrical | ◯ | ◯ | ◯ | ◯ | ◯ | ◯ | to evaluate | ◯ | ◯ | to evaluate | to evaluate |
| | | characteristics | | | | | | | | | | | |
| | | Flexibility | X | ◯ | ◯ | X | ◯ | X | | ◯ | ◯ | | |
| | | Mechanical strength | ◯ | X | ◯ | ◯ | X | ◯ | | X | ◯ | | |
| | | Amount of produced | ◯ | ◯ | X | ◯ | ◯ | ◯ | ◯ | ◯ | ◯ | ◯ | ◯ |
| | | carbon monoxide | | | | | | | | | | | |
| | Outer | Storage stability at | ◯ | X | ◯ | ◯ | ◯ | ◯ | ◯ | X | ◯ | ◯ | ◯ |
| | layer | room temperature | | | | | | | | | | | |
| | | Tensile strength (MPa) | 11.8 | 15.6 | 16.2 | 12.5 | 12.3 | 9.5 | 10.2 | 13.5 | 13.4 | 13.4 | 13.4 |
| | | | ◯ | ◯ | ◯ | ◯ | ◯ | X | ◯ | ◯ | ◯ | ◯ | ◯ |
| | | Elongation (%) | 320 | 123 | 90 | 280 | 290 | 90 | 130 | 230 | 127 | 127 | 127 |
| | | | ◯ | ◯ | X | ◯ | ◯ | X | ◯ | ◯ | ◯ | ◯ | ◯ |

| | | | | | | | | | | | | |
|---|---|---|---|---|---|---|---|---|---|---|---|---|
| Fuel | Tensile | 89 | 95 | 94 | 68 | 79 | 85 | 78 | 69 | 89 | 89 | 89 |
| resistance | strength | ◯ | ◯ | ◯ | X | ◯ | ◯ | ◯ | X | ◯ | ◯ | ◯ |
| | retention | | | | | | | | | | | |
| | (%) | | | | | | | | | | | |
| | Elongation | 95 | 93 | 98 | 59 | 92 | 99 | 90 | 50 | 95 | 95 | 95 |
| | retention | ◯ | ◯ | ◯ | X | ◯ | ◯ | ◯ | X | ◯ | ◯ | ◯ |
| | (%) | | | | | | | | | | | |

| | | | | | | | | | | | |
|---|---|---|---|---|---|---|---|---|---|---|---|
| Cold resistance | ◯ | ◯ | ◯ | X | ◯ | ◯ | X | ◯ | ◯ | ◯ | ◯ |
| Flame retardancy | X | ◯ | ◯ | ◯ | X | ◯ | ◯ | ◯ | ◯ | ◯ | ◯ |

| | | | | | | | | | | | |
|---|---|---|---|---|---|---|---|---|---|---|---|
| Overall Evaluation | X | X | X | X | X | X | X | X | X | X | X |

### (5) Evaluation Results

### (5)-1 Evaluation of Inner Layer

In Examples 1 to 16, the halogen-free resin compositions for inner layer did not block and were excellent in storage stability at room temperature, as shown in Table 5. In addition, since scorching of the halogen-free resin compositions did not occur, extrusion processability was good. Also, the inner layers were excellent in outer appearance, electrical characteristics, flexibility and mechanical strength and produced only small amount of carbon monoxide.

In Comparative Example 1, since only the first copolymer (a1) was used without using the second copolymer (a2), flexibility of the inner layer was low, as shown in Table 6.

In Comparative Example 2, since the first copolymer (a1) was contained in an amount of 40 parts by mass, i.e., the proportion of the first copolymer (a1) in 100 parts by mass of the base polymer (A) was less than 50 mass %, mechanical strength of the inner layer was low.

In Comparative Example 3, since the inorganic filler (B) was contained in an amount of 70 parts by mass, i.e., less than 80 parts by mass, a large amount of carbon monoxide was produced when the inner layer was burnt. On the other hand, in Comparative Example 4, since the inorganic filler (B) was contained in an amount of 160 parts by mass, i.e., more than 150 parts by mass, flexibility of the inner layer was low.

In Comparative Example 5, since the first copolymer (a1) having a low density of 0.862 g/cm³ was used, mechanical strength of the inner layer was low. On the other hand, in Comparative Example 6, since the first copolymer (a1) having a high density of 0.893 g/cm³ was used, flexibility of the inner layer was low.

In Comparative Example 7, since the first copolymer (a1) having a low MFR of 0.5 g/10 min, i.e., less than 1 g/10 min was used, extrusion processability of the halogen-free resin composition was poor. Due to poor extrusion processability, it was not possible to extrude the halogen-free resin composition to form the inner layer. Since it was not possible to form the inner layer, it was not possible to evaluate outer appearance, electrical characteristics, flexibility and mechanical characteristics of the inner layer.

In Comparative Example 8, since the first copolymer (a1) having a high MFR of 8 g/10 min, i.e., more than 5 g/10 min was used, mechanical strength of the inner layer was low.

In Comparative Example 9, since the first copolymer (a1) having a melting point of 93° C., i.e., more than 90° C. was used, scorching of the halogen-free resin composition occurred and extrusion processability was poor. Therefore, outer appearance of the formed inner layer was rough and appearance after extrusion was poor.

In Comparative Example 10, since the second copolymer (a2) having a low MFR of 16 g/10 min and a low melting point of 53° C. was used, blocking of the halogen-free resin composition occurred. In addition, since it was difficult to extrude the halogen-free resin composition and the discharge rate was thus low, it was not possible to form the inner layer by extrusion. Since it was not possible to form the inner layer, it was not possible to evaluate outer appearance, electrical characteristics, flexibility and mechanical characteristics of the inner layer.

In Comparative Example 11, since the second copolymer (a2) used had a melting point of less than 50° C. which is lower than that of the second copolymer (a2) in Comparative Example 10, blocking of the halogen-free resin composition occurred in the same manner as Comparative Example 10. In addition, extrusion processability of the halogen-free resin composition was poor and it was thus not possible to form the inner layer.

### (5)-2 Evaluation of Outer Layer

In Examples 1 to 16, the halogen-free flame-retardant resin compositions for outer layer did not block and were excellent in storage stability at room temperature, as shown in Table 5. Also, the outer layers were excellent in mechanical strength, fuel resistance, cold resistance and flame retardancy.

In Comparative Example 1, since the VA content in the base polymer (D) was less than 25 mass %, flame retardancy of the outer layer was low, as shown in Table 6.

In Comparative Example 2, since any EVA having a melting point of not less than 70° C. was not used as the EVA (d1) and also the VA content in the base polymer (D) was more than 50 mass %, blocking of the halogen-free flame-retardant resin composition occurred.

In Comparative Example 3, since the acid-modified polyolefin resin (d2) was contained in an amount of 35 parts by mass, i.e., the proportion of the acid-modified polyolefin resin (d2) in 100 parts by mass of the base polymer (D) was more than 30 mass %, an elongation characteristic of the outer layer was poor.

In Comparative Example 4, since the acid-modified polyolefin resin (d2) was not used, fuel resistance of the outer layer was poor. In addition, cracks were generated on the outer layer in the cold resistance test and it was thus confirmed that cold resistance of the outer layer was also poor.

In Comparative Example 5, since the halogen-free flame retardant (E) was contained in an amount of 90 parts by mass, i.e., less than 100 parts by mass, flame retardancy of the outer layer was low. On the other hand, in Comparative Example 6, since the halogen-free flame retardant (E) was contained in an amount of 260 parts by mass, i.e., more than 250 parts by mass, mechanical strength (tensile characteristics) of the outer layer was low.

In Comparative Example 7, since the acid-modified polyolefin resin (d2) having a glass-transition temperature of more than −55° C. was used, cold resistance of the outer layer was poor.

In Comparative Example 8, since the EVA (d1) having a melting point of less than 70° C. was used, blocking of the halogen-free flame-retardant resin composition occurred. Fuel resistance of the outer layer was also poor.

In Comparative Examples 9 to 11, the outer layers were excellent in all characteristics in the same manner as Examples 1 to 16.

As described above, in Examples 1 to 16, all characteristics of the inner and outer layers were evaluated as “◯” and the overall evaluation was thus rated as “◯ (good)”. In Comparative Examples 1 to 11, at least one of characteristics of the inner and outer layers was evaluated as “X” and the overall evaluation was thus rated as “X”.

### Preferred Embodiment of the Invention

The preferred embodiment of the invention will be described blow.

[1] In an embodiment of the invention, an insulated wire is provided with:

a conductor; and

an insulating cover layer having an inner layer provided on an outer periphery of the conductor and an outer layer provided on an outer periphery of the inner layer,

wherein the inner layer is formed of a halogen-free resin composition containing 100 parts by mass of base polymer (A), not less than 80 parts by mass and not more than 150 parts by mass of inorganic filler (B) and a cross-linking agent (C), the base polymer (A) containing a first ethylene-α-olefin copolymer (a1) and a second ethylene-α-olefin copolymer (a2) at a ratio of 50:50 to 90:10, the first ethylene-α-olefin copolymer (a1) having a density of not less than 0.864 g/cm³ and not more than 0.890 g/cm³, a melting point of not more than 90° C. and a melt flow rate of not less than 1 g/10 min and not more than 5 g/10 min, and the second ethylene-α-olefin copolymer (a2) having a melting point of not less than 55° C. and not more than 80° C. and a melt flow rate of not less than 30 g/10 min, and

the outer layer is formed of a halogen-free flame-retardant resin composition containing 100 parts by mass of base polymer (D) and not less than 100 parts by mass and not more than 250 parts by mass of halogen-free flame retardant (E), the base polymer (D) containing an ethylene-vinyl acetate copolymer (d1) including an ethylene vinyl acetate copolymer having a melting point of not less than 70° C. and an acid-modified polyolefin resin (d2) having a glass-transition temperature of not more than −55° C. at a ratio of 70:30 to 99:1, and the base polymer (D) containing not less than 25 mass % and not more than 50 mass % of vinyl acetate component derived from the ethylene-vinyl acetate copolymer (d1).

[2] In the insulated wire according to [1], an average particle size of the inorganic filler (B) is exemplarily not less than 0.8 μm and not more than 2.5 μm.

[3] In the insulated wire according to [1] or [2], the ethylene vinyl acetate copolymer having a melting point of not less than 70° C. has exemplarily a melt flow rate of not less than 6 g/10 min.

[4] In the insulated wire according to [1] to [3], the halogen-free flame retardant (E) is exemplarily a metal hydroxide.

[5] In the insulated wire according to [1] to [4], the halogen-free flame retardant (E) is exemplarily treated with silane or fatty acid.

What is claimed is:

1. An insulated wire, comprising:
a conductor; and
an insulating cover layer comprising an inner layer on an outer periphery of the conductor and an outer layer on an outer periphery of the inner layer,
wherein the inner layer comprises a halogen-free resin composition comprising 100 parts by mass of base polymer (A), not less than 80 parts by mass and not more than 150 parts by mass of inorganic filler (B) and a cross-linking agent (C),
wherein the base polymer (A) comprises a first ethylene-α-olefin copolymer (a1) and a second ethylene-α-olefin copolymer (a2) at a ratio of 50:50 to 90:10, the first ethylene-α-olefin copolymer (a1) having a density of not less than 0.864 g/cm³ and not more than 0.890 g/cm³, a melting point of not more than 90° C. and a melt flow rate of not less than 1 g/10 min and not more than 5 g/10 min, and the second ethylene-α-olefin copolymer (a2) having a melting point of not less than 55° C. and not more than 80° C. and a melt flow rate of not less than 30 g/10 min,
wherein the outer layer comprises a halogen-free flame-retardant resin composition comprising 100 parts by mass of base polymer (D) and not less than 100 parts by mass and not more than 250 parts by mass of halogen-free flame retardant (E),
wherein the base polymer (D) comprises an ethylene-vinyl acetate copolymer (d1) comprising an ethylene-vinyl acetate copolymer with a melting point of not less than 70° C. and an acid-modified polyolefin resin (d2) having a glass-transition temperature of not more than −55° C. at a ratio of 70:30 to 99:1, and
wherein the base polymer (D) further comprises not less than 25 mass % and not more than 50 mass % of vinyl acetate component derived from the ethylene-vinyl acetate copolymer (d1).

2. The insulated wire according to claim 1, wherein an average particle size of the inorganic filler (B) is not less than 0.8 μm and not more than 2.5 μm.

3. The insulated wire according to claim 1, wherein the ethylene vinyl acetate copolymer with a melting point of not less than 70° C. has a melt flow rate of not less than 6 g/10 min.

4. The insulated wire according to claim 1, wherein the halogen-free flame retardant (E) comprises a metal hydroxide.

5. The insulated wire according to claim 1, wherein the halogen-free flame retardant (E) is treated by silane or fatty acid.
